(19) United States
(12) Patent Application Publication
(10) Pub. No.: US 2006/0075803 A1
(43) Pub. Date: Apr. 13, 2006

(54) Polymer-based cantilever array with optical readout

(75) Inventors: Anja Boisen, Valby (DK); Maria Nordstrom, Malmo (SE); Montserrat Calleja Gomez, Madrid (ES)

Correspondence Address: FOLEY AND LARDNER LLP;SUITE 500, 3000 K STREET NW, WASHINGTON, DC, 20007, US

(73) Assignee: Danmarks Tekniske Universitet

(21) Appl. No.: 11/175,404

(22) Filed: Jul. 7, 2005

Related U.S. Application Data
(60) Provisional application No. 60/586,310, filed on Jul. 9, 2004.

(51) Int. Cl. G01N 21/47

(52) U.S. Cl. 73/31.06; 73/866.5; 356/614; 422/68.1; 435/287.1; 435/288.7

(57) ABSTRACT

A cantilever array for use as a sensor, e.g. a bio/chemical sensor is disclosed. The cantilever array comprises a platform and a multitude of polymer-based cantilevers attached to the platform. Each of the cantilevers is coupled to an optical sensing means adapted to sense deformations of an individual cantilever. The cantilevers may be coated with a first and/or a second layer, the first layer being a metal layer, such as a gold layer, the second layer being a molecular layer capable of functioning as a receptor layer for molecular recognition. Further, two methods of fabricating a cantilever array are disclosed, one being based on photolithography, the other being based on micromoulding.

### FIELD OF THE INVENTION

The invention relates to a cantilever array comprising a platform and methods of fabricating a cantilever array comprising a platform. The invention relates in particular to a polymer-based cantilever array.

### BACKGROUND OF THE INVENTION

Cantilever-based sensors have been used to monitor different physical and chemical processes by transducing changes in temperature, mass, electromagnetic field or surface stress into a mechanical response. Cantilever-based sensors have a wide range of applications in real-time local monitoring of chemical and/or biological applications. Normally, cantilevers used in cantilever-based bio/chemical detection are micrometer-sized cantilevers fabricated in silicon and designed for atomic force microscopy (AFM) imaging.

The fabrication and application of cantilever arrays have drawn interest since an array could provide for the capability of simultaneous multiple detection of a substance comprising different constituents. Silicon cantilever arrays have already been proposed for this purpose. Nevertheless, the sensitivity and stability of silicon should be improved for several applications (such as DNA sequencing). Si-based sensors are very sensitive to any environmental change, for example temperature or small pH changes in the solution to be measured.

Furthermore, the fabrication of silicon-based sensors is rather complicated due to the comprehensive process sequence required in order to fabricate such sensors. A consequence of the comprehensive process sequence is directly reflected in the fabrication costs, causing silicon-based sensors to be very expensive.

In WO 03/022731 a polymer-based flexible structure with integrated sensing/actuator is disclosed. By incorporating a gold resistor in an SU-8 based polymer structure an SU-8 based cantilever sensor, which is almost as sensitive to stress changes as a silicon-based cantilever with piezo-resistive read-out is achieved.

### SUMMARY OF THE INVENTION

The present invention seeks to provide an improved cantilever-based sensor.

It is an object of the invention to provide local, high resolution and label-free molecular recognition measurements on a stable and sensitive portable device.

It is a further object of the invention to provide a real-time local monitoring of chemical and biological interactions.

It is an even further object of the invention to provide a sensor capable of simultaneous detection of several chemical, biological and/or biochemical substances, both gaseous substances as well as liquid substances, for example in connection with high-throughput screening (HTS).

It is an even further object of the invention to provide a sensor which is cheap to fabricate.

It is an even further object of the invention to provide a sensor with an improved stability and sensitivity compared to silicon-based cantilever sensors.

According to the above and other objects of the invention, there is provided a polymer-based cantilever array as well as methods of fabricating such a cantilever array.

According to a first aspect, there is provided a cantilever array comprising a platform and at least two polymer-based cantilevers attached to the platform, and wherein each of the cantilevers is coupled to an optical sensing means adapted to sense deformations of an individual cantilever.

Cantilevers used in cantilever-based bio/chemical detection have traditionally been fabricated in silicon and designed for atomic force microscopy (AFM). It is an advantage to provide cantilevers that are designed and fabricated with the intent to be used only as bio/chemical sensors. A further advantage is that by use of a polymer material, the fabrication process is rendered simple, cheap, fast and flexible. It is an advantage that a cheap device may be provided, e.g. since a cantilever array may be used to measure chemical and/or biological substances which may be difficult to, time consuming to or even toxic to clean off a device, rendering it desirable to provide a disposable device. An even further advantage of using polymer-based cantilevers is that polymer-based cantilevers may be less sensitive to any environmental changes, for example temperature or small pH changes in the solutions to be measured.

A cantilever may be a micrometer-sized beam attached to a platform in one end of the beam. However, the term cantilever should be construed more broadly, and should be construed to at least include a bridge structure, where at beam is clamped in two ends, as well as to include a diaphragm or membrane structure attached to a platform along parts of, or the entire, periphery. However, in general the term should be construed to include a sub-micrometer or micrometer-sized flexible structure coupled to a sensing means so that deformations of the structure may be deduced. The deformation may be any type of deformation, such as any type of movement of a cantilever. The deformation may be a static or dynamic deformation, such as bending, twisting, oscillating, etc.

Sensors based on the cantilever principle offer the possibility of performing local, high-resolution measurements on a portable device in real-time. By providing an array of cantilevers it is rendered possible to detect multiple different targets simultaneously, such as detecting different chemicals in a solution or a gas. The polymer fabrication provides a convenient way for realising arrays of multiple sensors and to integrate them into a miniaturized bio/chemical analysis system.

The platform may be of any shape and/or size suitable to carry a cantilever array in a situation of use. The platform may be a adapted to be fastened to a sensor system, such as adapted to be attached in a measuring chamber such as in a liquid cell system and/or in a gas handling system, or any system in which actual measurements are to take place.

The cantilever array may comprise a multitude of cantilevers, such as 2-3, such as 2-5, such as 5-10, such as 10-20, such as 20-50 or even more cantilevers, such as more than hundred cantilevers or even more than thousand cantilevers. The cantilevers in the array may all be similar in terms of mechanical and chemical properties, groups of similar cantilevers may be provided, or all of the cantilever in an array may be provided with different mechanical and/or chemical properties. It may be an advantage to provide similar cantilevers e.g. to compare the signal from different cantilevers with similar properties to obtain a better certainty of the measurements. However it may also be an advantage to provide different properties of the cantilevers in order to provide a versatile sensor device.

The deformation of a cantilever is most commonly recorded optically by shining a light beam onto the cantilever and monitoring the reflection of the cantilever beam by means of a photosensitive detector, such as a photodiode. The optical sensing means may, thus, include a light emitter and a light detector. The light emitter may be a low energy laser device, such as a solid state laser e.g. a laser diode or a vertical cavity surface-emitting laser (VSCEL) emitting at an appropriate wavelength, such as in the infra red, the visual or the ultraviolet wavelength range. In many applications the wavelength of the light emitting device may not be important, however in measurements where the emitting light may interact with the substance to be detected and possible cause light-induced reactions, to obtain a better reflectivity or for other reasons, the wavelength may be chosen accordingly.

The optical sensing means may more specifically comprise a light source that directs a beam of light onto a cantilever in the cantilever array and a position sensitive detector that receives light reflected by the cantilever, and wherein a deformation of the cantilever is deduced by a detected position of the light beam on the position sensitive detector. Such a set-up is well known in connection with silicon-based cantilever sensors. Further, the components of the sensing means being well-known components, such as a laser, and a position sensitive detector, such as a segmented photodiode or a CCD-type detector. It is an advantage to be able to use well-known components in conjunction with the cantilever array of the present invention, since many laboratories already possess such components and the cantilever array of the present invention may thus easily be combined with existing equipment in many laboratories. Alternatively, the optical sensing means may be provided in a pre-fabricated assembly adapted to fit to an embodiment of the present invention.

The sensing means may comprise two or more light sources, and wherein the two or more light sources are directed to different cantilevers in the cantilever array. Likewise, the sensing means may comprise two or more position sensitive photodetectors, and wherein the two or more position sensitive photodetectors receive light from different cantilevers in the cantilever array. It may be an advantage to use more than one light source and/or more than one photodetector in order to simultaneously detecting a deformation of the individual cantilevers. As an alternative to using two or more light sources and/or photodetectors, only one light source and only one photodetector may be used in conjunction with an optical element capable of directing a single light beam to two or more cantilevers. The optical element may be one or more mirrors, beam splitters, gratings, etc. The signal arising from the deflection from the two or more cantilevers may be used to deduce the deformation of the individual cantilevers, or it may be used to obtain an average signal used to deduce an average deformation of the cantilevers.

The beam of light may be directed to two or more cantilevers, and wherein the deformations of the two or more cantilevers may be deduced by a detected signal from the two or more cantilevers. In this way an average signal from the two or more cantilevers may be used to deduce the deformation of the cantilevers.

A cantilever in the cantilever array may be provided with a first layer. The first layer may be a metal layer, such as a layer of Au, Ag, Pt, Pd, Al Cr, Ti, Cu, Ru, Rh, or any combination or alloying of such or other metals. The first layer may be provided by vapour deposition, precipitation, laser ablation, electron beam evaporation, electroplating, shadow masking, or any other suitable technique for providing a metal layer. The first layer may have a thickness between a few nanometres to a few hundreds nanometres. The first layer may be provided to an outer surface of a cantilever. The outer surface may e.g. be, or be a part of, a top or a bottom surface of a cantilever. The first layer may also be provided as an embedded layer in a cantilever. By providing the first layer as an embedded layer a possible bimorph effect may be avoided or minimized. In principle, the first layer may be of any material which reflects at least a measurable fraction of light incident onto the layer.

In addition to being reflective, the layer may also be capable of immobilization of relevant molecules, such as by means of van der Waals interactions, electrostatic interactions, steric interaction, chemisorption, physisorption, or any other way of binding between a relevant molecule and the surface of the first layer. The relevant molecule may be of a molecular species which is desirable to detect by the sensor, or the relevant molecule may be the molecular constituents of a second layer. A second layer may be provided onto a first layer provided on an outer surface of a cantilever in the cantilever array. The second layer may also be provided directly onto an outer surface of a cantilever in the cantilever array.

An outer surface of a cantilever may be surface treated prior to, or as an alternative to, providing the first layer and/or the second layer. For example, an outer surface may be roughened. A rough surface may promote attachment of chemical substances to the surface, such as promote immobilization of molecular species directly on the polymer. A surface treatment may be provided to a second outer surface whereas a first layer is provided to a first outer surface or embedded in the cantilever array. The first and second outer surfaces being e.g. a lower and an upper surface of a cantilever beam.

The at least second layer may be a molecular layer, such as a layer of receptor molecules, capable of selectively binding specific molecules, such as macro-molecules, bio-molecules, DNA, amino acids, proteins, cells, various drug molecules, constituents of explosives, traces of toxins, warfare agent, etc. The at least second layer may be a self-assembled layer, such as a self-assembled monolayer.

The first and the at least second layer, may be at least two different first layers and/or second layers that are provided onto at least two different cantilevers in the cantilever array. It may be an advantage to be able to adjust the chemical and/or biological properties of the individual cantilever in accordance with the desired substance to detect.

At least one cantilever of the at least two cantilevers may in a situation of use be a reference cantilever used to obtain a reference signal. It may be an advantage to be able to obtain a reference signal simultaneously with obtaining a detection signal, since the reference signal may be used to filter away noise, such as artificial cantilever signals arising form e.g. thermal drift or transient phenomena such as fluctuations in flow speed, fluctuations in concentration, changes in optical properties of the liquid, etc.

The material of the polymer-based cantilevers may be any suitable type of natural or synthetic polymer-based material or co-polymer-based material which may sustain a stable structure in the micrometer or sub-micrometer range. The polymer-based material may be a plastic material, such as a thermoplastic or a thermoset, or such as a so-called photoplastic, i.e. a plastic material that may be photolithographically processed. The material of polymer-based cantilevers may be selected from the group consisting of: SU-8 based polymers, such as XP SU-8 polymer, polyimides or BCB cyclotene polymers and parylene, but many other polymer-based materials or plastic materials could be used. The chemical name of SU-8 is glycidyl ether of bisphenol A. SU-8 may be a suitable component for fabricating a cantilever array since it has a high chemical resistance, it is compatible with conventional microfabrication techniques, capable of supporting very high aspect ratios and it is relatively easy and fast to process.

It is an advantage to provide a polymer-based material for the cantilever since compared to a silicon-based cantilever a more stabile as well as a more sensitive sensor system may be provided.

The sensitivity of a cantilever is given by its dimensions and mechanical material properties. The polymer SU-8 has a Young's modulus of about 5 GPa, 40 times smaller than that of silicon. It is an advantage to provide a cantilever with a Young's modulus smaller than that of silicon, or silicon nitride (Si₃N₄), since the lower Young's modulus renders the cantilever more sensitive. Thereby, the sensitivity for surface stress measurements is much greater for cantilevers fabricated in SU-8, than for cantilevers fabricated in e.g. Si or Si₃N₄ with the same dimensions.

The individual cantilevers in an array may during fabrication be provided with different mechanical properties by providing different dimensions to the cantilevers. It may be an advantage to provide a cantilever array wherein at least two of the cantilevers are provided with different geometrical dimensions, since a more versatile device may be provided.

The polymer-based cantilevers and the platform may be made from the same material, e.g. both are made from SU-8. It may be an advantage to provide the cantilevers and the platform in the same material, since better integration of the cantilever and the platform may be obtained, than if the cantilevers and the platform were made form two different materials. Additionally, by using as few materials as possible for the complete device, the number of steps necessary to fabricate the device may by reduced.

According to a second aspect of the invention, a method of fabricating a cantilever array comprising a platform and at least two polymer-based cantilevers attached to the platform is provided. The method being a lithography process including the step of spin-coating the polymer layer on a support and patterning the polymer layer to define the cantilevers, the lithographic process further including providing a first layer to the cantilevers, the first layer being a reflective layer.

According to a third aspect of the invention, a method of fabricating a cantilever array comprising a platform and at least two polymer-based cantilevers attached to the platform is provided. The method is a micromoulding technique where a polymer-based material is provided into a mould and pressed so as to obtain a polymer-based structure, and wherein a first layer is provided to an outer surface of the cantilevers after the moulding process, the first layer being a reflective layer. The first layer may alternatively be provided as an embedded layer in a sequential moulding process.

It is an advantage that the device of the present invention, i.e. the cantilever array, may be fabricated by means of different fabrication methods. In the fabrication method according to the second aspect of the invention, photosensitive polymer-based materials may be processed, whereas in the fabrication method according to the third aspect of the invention, non-photosensitive polymer-based materials may be processed. Thus, the fabrication method may be chosen e.g. on the basis of desired properties, or desired material choice, of the device in a situation of use.

These and other aspects, features and/or advantages of the invention will be apparent from and elucidated with reference to the embodiments described hereinafter.

### BRIEF DESCRIPTION OF THE DRAWINGS

Preferred embodiments of the invention will now be described in details with reference to the drawings in which:

FIG. 1 illustrates a schematic drawing of a polymer-based cantilever array (1A) and an optical image of a cantilever array (1B).

FIG. 2 illustrates the sensor principle for molecular recognition of the cantilever array.

FIG. 3 illustrates static mode detection of deformation of the cantilever (3A) and dynamic mode detection (3B).

FIG. 4 illustrates alternative ways of detecting cantilever bending.

FIG. 5 illustrates a cantilever array.

FIG. 6 illustrates selective sensing of a specific molecule for a cantilever array immersed in a solution comprising different molecules.

FIG. 7 illustrates a first method of fabricating a polymer-based cantilever array, the method being based on spin-coating and lithography.

FIG. 8 illustrates a second method of fabricating a polymer-based cantilever array, the method being based on micromoulding.

FIG. 9 shows a Fast Fourier Transform (FFT) of a photodetector noise.

FIG. 10 shows the deflection signal during the injection of 1 mM cystamine in water.

FIG. 11 shows the deflection signal during injection of 20 ml of a 2 μM solution of thiolated ssDNA in buffer solution on a cantilever according to the present invention.

FIG. 12 shows the deflection signal as in FIG. 11, expect that the signal was obtained from a commercial silicon nitride cantilever.

FIG. 13 shows a comparison between the response to temperature changes of an SU-8 cantilever and a Silicon cantilever.

FIG. 14 shows a comparison between the response to pH changes of an SU-8 cantilever and a Silicon cantilever.

### DESCRIPTION OF PREFERRED EMBODIMENTS

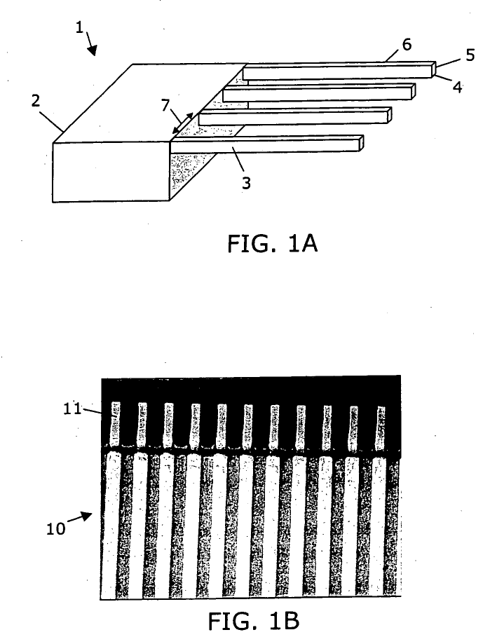

A schematic drawing of a polymer-based cantilever array is shown in FIG. 1A and in FIG. 1B an optical image of a cantilever array is provided.

In FIG. 1A a cantilever array 1 comprising a platform 2 and a number of cantilevers 3 is illustrated. The number of cantilevers 3 may vary, however more than two are always present, but 3-5, 5-10, or even 100 or more cantilevers, such as a multitude of cantilevers may be attached to, or protrude from, a platform. The cantilevers and the platform may be provided in different materials, however in the embodiments described here, the cantilevers and the platform are of the same material. The size and shape of the cantilevers may vary and depend upon the intended application. Here the cantilevers have a rectangular cross-section, however cantilever with a round, a quadratic or any suitable cross-section may be envisioned. For a cantilever with a rectangular cross-section a typical length 6 of a cantilever is between 100 and 200 micrometers, a typical thickness 5 is between 1 and 5 micrometers and a typical width is between 10 and 25 micrometers. The individual cantilevers are typically separated along a side of the platform by a distance 7 of 50 to 100 micrometers. The size of the cantilever platform may typically be in the millimetre or centimetre range. The size ranges provided above, are only provided to illustrate a typical situation and should not be taken as a limiting factor of the dimension of a cantilever and/or a cantilever array, any suitable dimension of a cantilever, a cantilever array or a platform may be used.

Design parameters and corresponding calculated and measured resonance frequencies, as well as calculated and measured elastic constants are present in the below table. To calculate the elastic constant and resonance frequency a value of 5 GPa was considered for SU-8:

| Length | Width | Thickness | f_{calculated} | f_{measured} | k_{calculated} | k_{measured} |
|---|---|---|---|---|---|---|
| (μm) | (μm) | (μm) | (KHz) | (KHz) | (N/m) | (N/m) |
| 200 | 20 | 1.5 | 16 | 17 | 0.015 | 0.0245 ± |
| | | | | | | 0.0011 |
| 200 | 50 | 1.7 | 16 | 15 | 0.038 | 0.0640 ± |
| | | | | | | 0.0015 |
| 100 | 20 | 1.5 | 63 | — | 0.122 | 0.286 ± |
| | | | | | | 0.017 |

In FIG. 1B an optical image of a cantilever array 10 fabricated in SU-8 is provided. The cantilevers 11 are in this example 100 micrometers long, with a width of 20 micrometers and a separation of 100 micrometers.

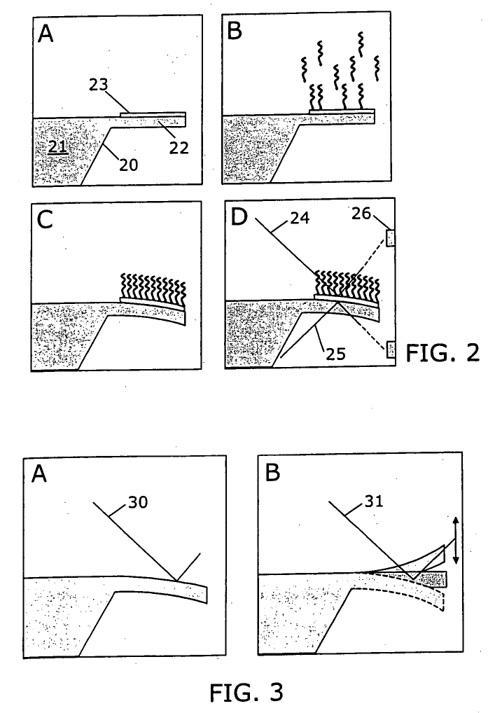

In FIG. 2, the sensor principle for molecular recognition of the cantilever array is illustrated. In the figure a cantilever array 20 is seen from the side, the cantilever array comprising a platform 21 and a number of cantilevers 22. One side of the cantilevers are covered by a first layer 23, such as a metal layer, or more specifically such as a gold layer. In the figure the metal layer is provided on the top side of the cantilever, however the layer may alternatively be provided on the bottom side. It is, however important that the two sides are provided with two different surfaces in order to induce a differential surface stress on the two sides, since it is the differential surface stress that will cause the cantilever to bend (FIG. 2C). In FIG. 2B the cantilever array is immersed in a solution of e.g. a self-assembling alkanethiol. The gold layer allows for adsorption, or immobilization of different molecules specifically on one side of the cantilever through S—Au bond. The bending of the cantilever may be monitored by detecting the reflection of a laser beam 24, 25 from the back of the cantilever (FIG. 2D), the laser beam being detected by a photodiode 26.

The laser spot may be focused either on top of the gold layer 24, or through the transparent polymer on the bottom of the gold layer 25, i.e. on the interface between the gold layer and the cantilever polymer layer. It may be an advantage to focus through the polymer layer, since the gold surface in the interface between the gold layer and the cantilever may be cleaner than the gold surface exposed to the environment. In case the reflective layer is provided as an embedded layer (not shown) is it necessary to focus through the polymer layer either through the top or bottom surface. As an alternative to move the photodiode (or use two photodiodes), the cantilever array may be turned upside down (not shown).

In general molecular layers are known to induce surface stress when they bind to a surface, due to van der Waals, electrostatic or steric interactions. A monolayer of receptor molecules is immobilized on one side of the cantilever so the molecules to be detected bind specifically to the target layer, such as a gold layer, and then difference in surface stress on opposite sides of the cantilever is measured. The cantilever deflection, Δz, resulting from this difference in surface stress can be approximated by (J. E. Sader, J. of Applied Physics, vol. 89, p. 2911 (2001)):

$$Δ z ≅ \frac{3 ( 1 - ν ) {L}^{2}}{{Et}^{2}} ( {Δσ}_{1} - {Δσ}_{2} )$$

where E is the Young's modulus, ν is Poisson ratio, t and L are thickness and length of the beam and νσ₁−Δσ₂ accounts for the differential surface stress.

In connection with FIG. 2 static bending (static mode) of the cantilever is discussed. In FIG. 3A static bending of the cantilever is illustrated as opposed to dynamic mode detection illustrated in FIG. 3B. In the static mode of operation, a laser beam 30 is focused on the back of the cantilever and reflected to a segmented photodiode. Cantilever movements may be recorded as the current intensity difference between upper and lower segments in he photodiode. The deflection of the cantilever in the nanometer range is amplified by the photodetector. In dynamic mode detection, the cantilever is oscillated, e.g. by means of a piezo-oscillator attached to the platform, the bending of the cantilever is monitored by detecting the reflection of a laser beam 31 from the cantilever on a photo-diode. From the measured signal, the changes in the resonant frequency of the cantilever from the immobilization of molecules onto the cantilever is deduced. The resonance frequency of a cantilever depends, inter alia, on the cantilever mass, near environment viscosity and surface stress.

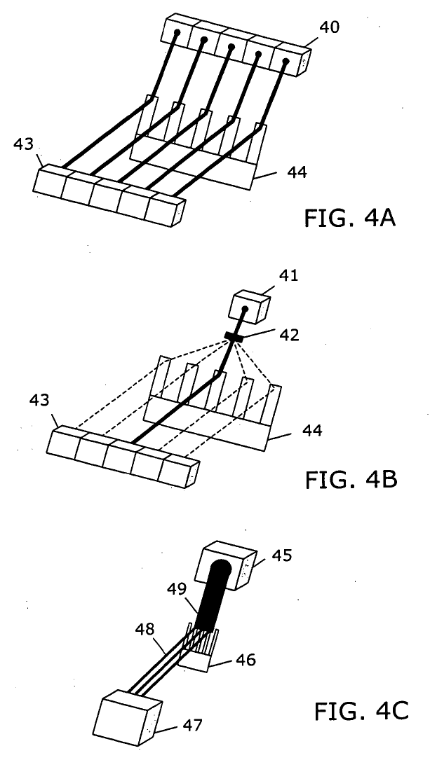

In FIG. 4 alternative ways of detecting cantilever bending is illustrated. In. FIG. 4A the bending of multiple cantilevers 44 are monitored by using a laser array 40, such as a VSCEL array. Whereas in FIG. 4B the bending of multiple cantilevers 44 are monitored by using a single laser diode 41 in combination with one or more optical elements 42, such as a mirror, directing the beam to the desired cantilever. In both figures the beams are detected by an array of position-sensitive photodiodes 43 However, also a single photosensitive detector may be used. The single photosensitive detector may possess an active area large enough to cover all beams or used in connection with one or more optical elements directing the various beams to the detector.

In FIG. 4C a single light beam 49 provided from a light source 45 is incident onto a two or more cantilevers in the cantilever array 46. One reflected beam per cantilever is measured either by use of a single photodetector 47 or by use of an array of photodetectors 43.

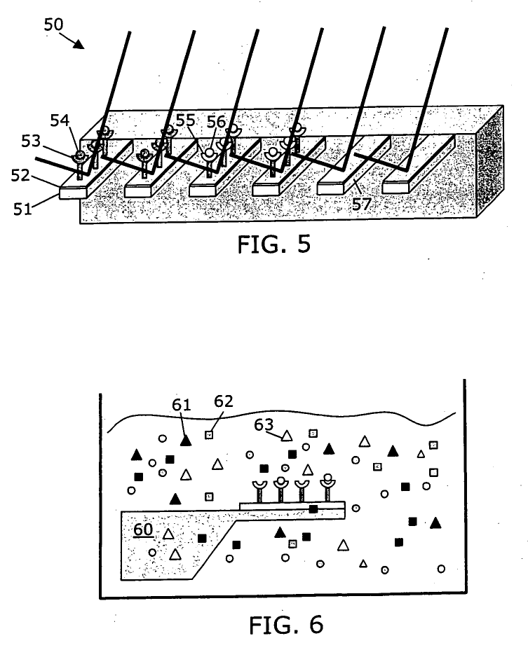

In FIG. 5 a cantilever array 50 where in addition to a first layer being a reflective metal layer 52 provided on one side of a cantilever 51, a second layer 53 is provided onto the first layer. The second layer is a molecular layer capable of selective bonding to specific molecules. For the cantilever array in FIG. 5, the first layer 52 is typically a gold layer. The gold layer being used as a reflective layer for reflecting the light beam, and the first layer 52 being used to immobilize a second layer, being a molecular layer, the second layer being used as a sensor or receptor layer.

In the embodiment illustrated in FIG. 5, the first layer is of the same material for all of the cantilevers in the cantilever array. On two of the cantilevers, a first type of a second layer 53 is provided, on other two of the cantilevers, a second type of a second layer 55 is provided, and on yet other of the cantilevers 57, a second layer is not provided. By not providing a second layer on one or more cantilevers, the signal from such cantilevers may be used as reference cantilever(s), used to filtrate background noise away. Alternatively, a reference cantilever may be provided with a layer which does not act as a detector. In this way the reference cantilever may be made as identical to the other cantilevers as possible.

By providing different types of second layers on different cantilevers, the presence of different molecules in a solution may be detected. This is illustrated in FIG. 6.

In FIG. 6 a cantilever array 60 as described in connection with FIG. 5 is immersed in a solution comprising different molecules 61, 62, 63. By selecting appropriate second layers, the presence of various molecules in the solution may be selectively detected.

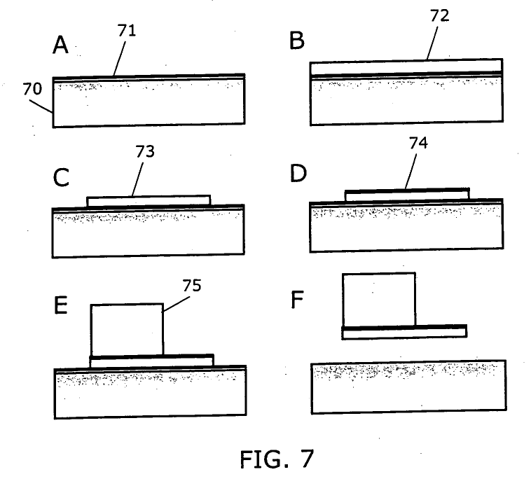

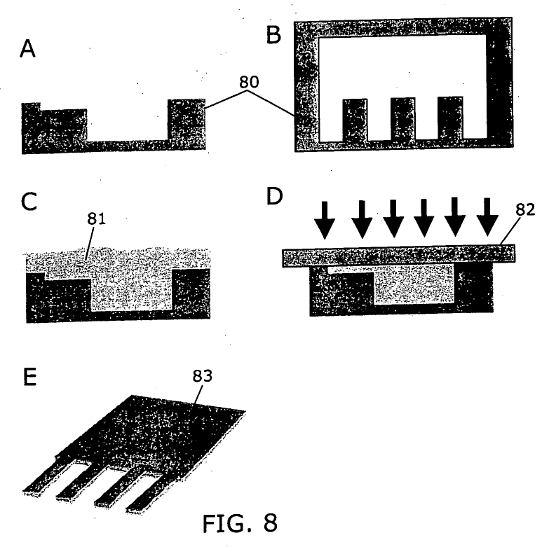

Different polymer materials may be used to fabricate the polymer-based cantilever array. In a preferred embodiment the photosensitive polymer SU-8 is used. In FIGS. 7 and 8 two methods of fabricating a cantilever array are illustrated. It is to be understood, that alternative polymer materials may be used, such as parylene or any other suitable material.

In FIG. 7 a first method of fabricating an SU-8 cantilever array is described. A silicon wafer 70, such as a 4″ <100>-terminated Si wafer, is used during the process as a support of the cantilever array. Firstly in FIG. 7A, a release layer 71 of 5 nm/50 nm/50 nm Cr/Au/Cr is deposited onto the wafer. This metal layer will be used in a later process stage to release the cantilever array from the wafer in a wet chromium etch. In FIG. 7B a layer of SU-8 is spin-coated on top of the release layer. The SU-8 layer 72 is spun over the wafer (500 rpm for 5 s, followed by 5000 rpm for 30 s) resulting in a 1.5 μm thick layer (other thicknesses may be provided by using different spinning parameters). The layer is pre-baked at 90° C. to evaporate most of the solvent. In FIG. 7C the cantilever geometry 73 (seen in cross-section) is patterned by UV exposure with a wavelength of 365 nm at a dose of 450 mJ/cm². The resist is post-baked at 90° C. for 4 minutes to further promote the crosslinking of UV-exposed SU-8. Afterwards, the remaining non-crosslinked SU-8 is removed by immersion for 2 minutes in an SU-8 developer (propylene glycol monomethyl ether acetate, PGMEA). On top of the SU-8 resist a gold layer 74 is deposited by electron beam evaporation (FIG. 7D). A thin titanium layer is used to improve the adhesion of gold to SU-8. The gold layer allows for reflection of the laser beam, and it is also crucial for surface stress-based bio/chemical detection, in which composition of the opposite surfaces must be different for differential adsorption. Moreover, the gold coating is ideal for strong anchorage of proteins and nucleic acids using self-assembly chemistry. Afterwards, the SU-8 is hard baked at 120° C. for 1 minute. Finally, a 400 μm thick layer 75 of SU-8 is spun onto the wafer to define the platform for the cantilever array structure (FIG. 7E) and the completed devices are released in wet chromium etch (FIG. 7F). An optical image of the finished devices is shown in FIG. 1B. In the cantilever array illustrated in FIG. 1B, the cantilevers are geometrically identical. However, in the exposure-step where the width and the length of the individual cantilevers are determined, different geometry for the individual cantilevers may be provided, or different geometry for groups of the cantilevers may be provided. Cantilever thickness can be tunes by simply using different spinning speeds during polymer deposition. Even by using the same photolithography masks and in the same batch or even in the same array of cantilevers, cantilevers with different mechanical properties can be realized.

A second method of fabricating an SU-8 cantilever array is illustrated in FIG. 8. In the second method of fabricating the cantilever array, a micromoulding technique is used. In FIG. 8A a cross-section of the micromould 80 is illustrated, whereas a top view of the mould is illustrated in FIG. 8B. The mould may be fabricated in silicon or any other suitable material. In FIG. 8C polymer material 81 is filled into the mould and pressure is applied to shape the polymer and to get a flat surface. The pressure is applied (FIG. 8D) by pressing a plate 82 against the micromould and thereby applying pressure to the polymer material encapsulated by the mould and the plate. The moulded cantilever array may be released from the mould by using a sacrificial layer etch or by coating the mould with an anti-sticktion layer such as Teflon.

The individual cantilevers and/or groups of cantilevers may be provided with different shape, by providing a mould where the shape of the individual cantilever moulds are different. By using a mould for the fabrication of the cantilever array, a large freedom in the possible shapes of the resulting cantilevers is obtained. The plate 82 may be provided with a contoured surface facing the polymer material, so that a top shape of the cantilevers and/or the platform may be provided.

The cantilevers fabricated by one of the fabrication methods described in connection with FIGS. 7 and 8 are adequate to be used in both the static and dynamic modes of operation.

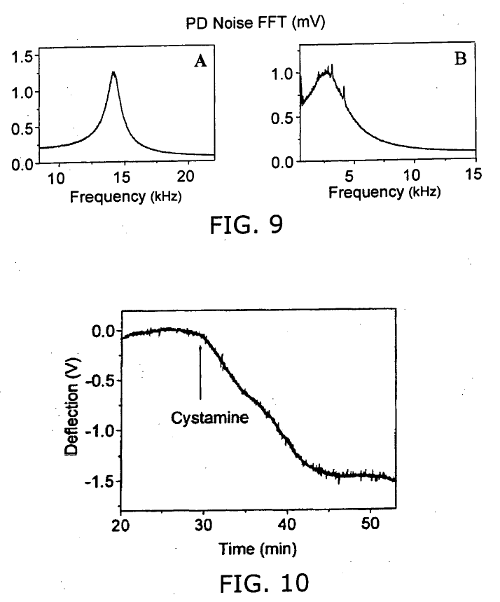

The dynamic response of the cantilevers can be characterized by measuring their Brownian motion produced by the thermal kicking forces. This was characterized by measuring the Fast Fourier Transform (FFT) of the photodetector noise with the cantilever in air (FIG. 9A) and water (FIG. 9B) for a 200 μm long cantilever. The noise is primarily partitioned around the resonant frequency, indicating that the dominant source of noise is the Brownian cantilever motion. The resonant peaks were fitted with the damped harmonic oscillator model to determine the resonant frequency and quality factor. Thus the resonant frequency and the quality factor in air were 14.14 kHz and 14.9, respectively, decreasing to 3.37 kHz and 1.44 when the cantilever was immersed in water. The decrease of the resonant frequency and the Q-factor is produced by the drag force, F_{d}, generated in liquids.

The value of the Q-factor in air is smaller than the typical values measured for conventional silicon technology microcantilevers. For instance, a silicon nitride beam-shaped cantilever with the same width and length as the SU-8 cantilever in FIG. 9, has a Q-factor of 40.

The values measured for the resonant frequency of the SU-8 cantilevers were used to derive the Young's modulus of SU-8. A value of 4.8±1.5 GPa was found. This is in good agreement with reported Young's modulus for crosslinked SU-8 after a hard-baking at 120° C.

The device performance was tested in the static mode by monitoring the process of functionalisation for subsequent protein attachment. FIG. 10 shows the deflection signal during the injection of 1 mM cystamine in water. The SU-8 cantilever was 200 μm long and 1.5 μm thick, with a measured elastic constant of 0.0245 N/m. Cystamine, —SH—(CH₂)₂—NH₂, is an amine terminated molecule that specifically forms self-assembled monolayers on gold surfaces due to the Au/S covalent bond. A downward deflection is observed during the formation of the self-assembled monolayer on the gold-coated side of the cantilever. This indicates that chemisorption of cystamine produces a compressive surface stress. This is related to the electronic redistribution on gold due to the S/Au bond. Cystamine attachment on the gold-coated side of the cantilever provides functionalisation with amine groups that allow protein attachment for molecular recognition measurements.

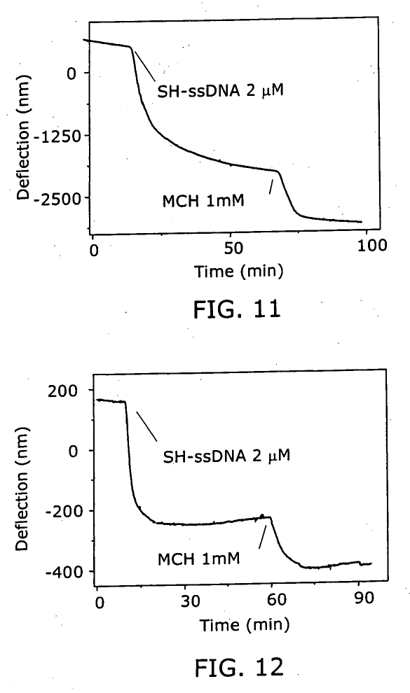

FIG. 11 shows the deflection signal during injection of 20 ml of a 2 μM solution of thiolated ssDNA in buffer solution. The SU-8 cantilever used for this experiment was 200 μm long and 1.3 μm thick. The thiolated ssDNA is a sulphur terminated molecule that specifically forms self-assembled monolayers on gold surfaces due to the Au/S bond. The cantilever is bending away from the gold coated surface during the formation of the self-assembled monolayer. This indicates that chemisorption of thiolated DNA produces a compressive surface stress. Cantilever bending after completion of the layer is around 2400 nm. Next, a solution of 1 mM of 6-mercapto-1-hexanol (MCH) was injected. MCH is a 6-carbon chain molecule terminated with thiol (—SH) and hydroxyl groups (—OH). This short molecule displaces the weakly adsorbed molecules, like the nucleotide chain-gold interactions. Also, since the hydroxyl group does not interact with the nucleotide chain, MCH acts as a spacer molecule between the DNA chains, enhancing the accessibility of ssDNA molecules for hybridization with complementary nucleic acids. A further downward deflection of approx. 1000 nm is observed after injection of the MCH.

For comparison, the same experiment as discussed in connection with FIG. 11 was repeated by using a commercial silicon nitride cantilever, the result is shown in FIG. 12.

The commercial silicon nitride cantilever was 0.8 μm thick, 200 μm long and 40 μm wide, with an elastic constant of 0.11 N/m. Here DNA immobilization produces a cantilever bending of only 400 nm, while MCH injection deflects the sensor by 150 nm.

Thus, a clear and high magnitude signals for this process is observed for the SU-8 cantilever compared to a silicon nitride commercial cantilever, the cantilever deflection for the immobilization of 2 μM thiolated ssDNA was six times larger for the polymeric probes of the present invention.

The elastic constant of SU-8 cantilevers 200 μm long and 1.3 μm thick is about 0.007 N/m. The hybridization of DNA to a target layer gives rise to a surface stress change of 1 mN/m. According to the Δz-equation as present above and for an SU-8 cantilever 200 μm long and 1.3 μm thick, a surface stress change of 1 mN/m would deflect the cantilever about 11 nm, which can be detected with the optical beam deflection method with a high signal-to-noise ratio. For the same differential surface stress a commercial silicon nitride cantilever as that in the experiments would only deflect 1.2 nm. Hence, considering a minimum detectable deflection of 0.5 nm, surface stress changes as small as 60 μN/m could be detected by SU-8 cantilevers.

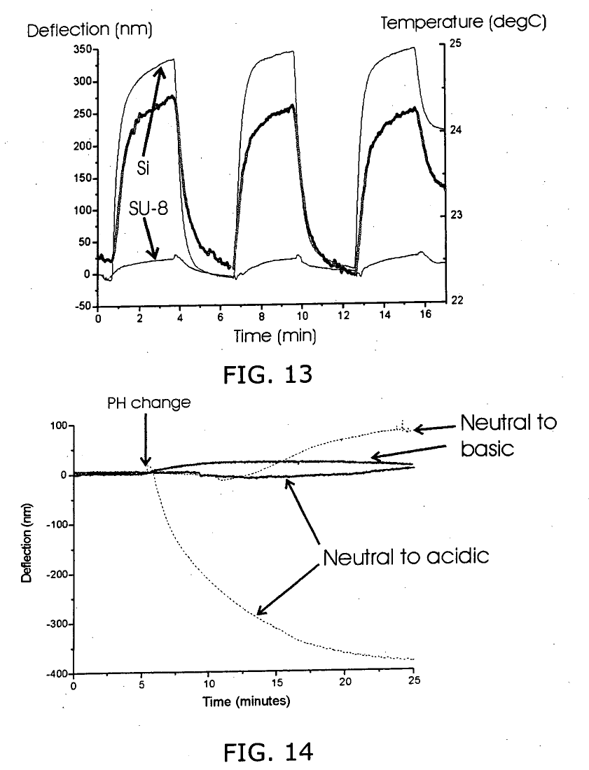

Conventional Si-based cantilever sensors are very sensitive to any environmental changes. Such drawbacks are being avoided, or at least diminished by use of SU-8 cantilevers. With SU-8 cantilevers it is possible to avoid the bi-material effect as the cantilevers are fabricated completely in SU-8. With conventional Si cantilevers, one surface must be coated with a gold layer for functionalisation of the cantilever and this leads to large drifts during measurements as Si and Au react differently to changes in temperature and pH. FIGS. 13 and 14 demonstrate the advantages of our SU-8 cantilevers with respect to temperature variations or changes in pH compared to conventional Si cantilevers.

FIG. 13 shows a comparison between the response to temperature changes of an SU-8 cantilever and a Silicon cantilever coated with a 20 nm layer of gold. Temperature variations are depicted by the central dotted line. The Si/Au cantilever is bending 13 times more than the non-coated SU-8 cantilever.

FIG. 14 shows a comparison between the response to pH changes of an SU-8 cantilever and a Silicon cantilever. For a pH change from neutral (pH 7) to acidic (pH 2) condition, the Si/Au cantilever experiences a 25 times larger bending than the SU-8 cantilever. For a change from neutral to basic (pH 12) the bending of the Si/Au cantilever is four times greater. The bending of the Si/Au cantilever is shown by the dotted lines and the behaviour of the SU-8 cantilever is shown by the straight lines.

In general it is possible to say that the material properties render the SU-8 cantilevers six times more sensitive and ten times less affected by noise, such as bending due to temperature variations or changes in pH.

Possible applications of the present invention include:

Molecular diagnosis
DNA biosensors
Immunoassays
Point-of-care diagnosis
Screening of food supplies
Veterinary diagnosis

Proteomics
Localisation of proteins with in living cells
Study of cell signalling pathways
Detection of protein-protein interactions

Drug discovery
Real-time monitoring of environmental toxins

Detection of biological and chemical warfare agents
Detection of explosives

The various applications may be rendered possible by choosing the appropriate first and/or second layer. The second layers may be provided using conventional immobilisation chemistry, including coating, photo-activated binding site, inkjet-printer principle, etc. Examples of second layers that may be used in connection with the above-mentioned applications include: single stranded DNA e.g. from disease-associated genes, antigens, nucleic acids, protein, cells, TNT, polymers etc.

It is to be understood that the application of the present invention is not limited to the above-listed examples.

Although the present invention has been described in connection with preferred embodiments, it is not intended to be limited to the specific form set forth herein. Rather, the scope of the present invention is limited only by the accompanying claims.

In this section, certain specific details of the disclosed embodiment such as material choices, geometry or architecture of the device or parts of the device, techniques, measurement set-ups, etc., are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

It will be appreciated that reference to the singular is also intended to encompass the plural and vice versa, and references to a specific numbers of features or devices are not to be construed as limiting the invention to that specific number of features or devices. Moreover, expressions such as “include”, “comprise”, “has”, “have”, “incorporate”, “contain” and “encompass” are to be construed to be non-exclusive, namely such expressions are to be construed not to exclude other items being present.

1. A cantilever array comprising a platform and at least two polymer-based cantilevers attached to the platform, and wherein each of the cantilevers is coupled to an optical sensing means adapted to sense deformations of an individual cantilever.

2. A cantilever array according to claim 1, wherein the optical sensing means comprises a light source that directs a beam of light onto a cantilever in the cantilever array and a position sensitive detector that receives light reflected by the cantilever, and wherein a deformation of the cantilever is deduced by a detected position of the light beam on the position sensitive detector.

3. A cantilever array according to claim 2, wherein the sensing means comprises two or more light sources, and wherein the two or more light sources are directed to different cantilevers in the cantilever array.

4. A cantilever array according to claim 2, wherein the sensing means comprises two or more position sensitive photodetectors, and wherein the two or more position sensitive photodetectors receive light from different cantilevers in the cantilever array.

5. A cantilever array according to claim 2, wherein the beam of light is directed to two or more cantilevers, and wherein the deformations of the two or more cantilevers are deduced by a detected signal from the two or more cantilevers.

6. A cantilever array according to claim 1, wherein a cantilever in the cantilever array is provided with a first layer.

7. A cantilever array according to claim 6, wherein an outer surface of a cantilever in the cantilever array is provided with at least a second layer.

8. A cantilever array according to claim 7, wherein at least two different first layers and/or second layers are provided onto at least two different cantilevers in the cantilever array.

9. A cantilever array according to claim 6, wherein the first layer is a metal layer.

10. A cantilever array according to claim 7, wherein the at least second layer is a molecular layer.

11. A cantilever array according to claim 1, wherein at least one cantilever of the at least two cantilevers in a situation of use is a reference cantilever used to obtain a reference signal.

12. A cantilever array according to claim 1, wherein the material of polymer-based cantilevers is selected from the group consisting of: SU-8 based polymers, such as XP SU-8 polymer, polyimides or BCB cyclotene polymers and parylene.

13. A cantilever array according to claim 1, wherein the polymer-based cantilevers and the platform are made from the same material.

14. A cantilever array according to claim 1, wherein the Young's modulus of the cantilevers is smaller than the Young's modulus of Silicon, i.e. smaller than 180 GPa.

15. A cantilever array according to claim 1, wherein at least two of the cantilevers in the cantilever array are provided with different mechanical properties.

16. A cantilever array according to claim 1, wherein at least two of the cantilevers in the cantilever array are provided with different chemical properties.

17. A method of fabricating a cantilever array comprising a platform and at least two polymer-based cantilevers attached to the platform, the method being a lithography process including the steps of spin-coating the polymer layer on a support and patterning the polymer layer to define the cantilevers, the lithographic process further including providing a first layer to the cantilevers, the first layer being a reflective layer.

18. A method according to claim 17, wherein at least a second layer is further provided to one or more cantilevers in the cantilever array, the second layer being provided in connection with the lithographic process or after the process has completed

19. A method according to claim 17, wherein the material of polymer-based cantilevers is selected from the group consisting of: SU-8 based polymers, such as XP SU-8 polymer, polyimides or BCB cyclotene polymers and parylene.

20. A method according to claim 17, wherein the platform is provided in the lithography process and wherein the polymer-based cantilevers and the platform are made from the same material.

21. A method according to claim 17, wherein at least two of the cantilevers in the cantilever array are provided with different mechanical properties by providing the cantilevers with different geometrical dimensions in the patterning process.

22. A method according to claim 17, wherein at least two of the cantilevers in the cantilever array are provided with different chemical properties by providing the cantilevers with different first or second layers.

23. A method of fabricating a cantilever array comprising a platform and at least two polymer-based cantilevers attached to the platform by a micromoulding technique where a polymer-based material is provided into a mould and pressed so as to obtain a polymer-based structure, and wherein a first layer is provided to the cantilevers, the first layer being a reflective layer.

24. A method according to claim 23, wherein at least a second layer is further provided to one or more cantilevers in the cantilever array.

25. A method according to claim 23, wherein a detection of a deformation of a cantilever in a situation of use is based on an optical read-out and wherein the light is reflected from the cantilever, the light being reflected by the reflective layer provided to the outer surface of a cantilever.

26. A method according to claim 23, wherein the material of polymer-based cantilevers is selected from the group consisting of: SU-8 based polymers, such as XP SU-8 polymer, polyimides or BCB cyclotene polymers and parylene.

27. A method according to claim 23, wherein at least two of the cantilevers in the cantilever array are provided with different mechanical properties by using a mould with different geometrical dimensions for at least two of the at least two cantilevers in the cantilever array.

28. A method according to claim 23, wherein at least two of the cantilevers in the cantilever array are provided with different chemical properties by providing the cantilevers with different first or second layers.

29. Use of the cantilever array according to claim 1, wherein the cantilever array is used for detecting the presence of a chemical substance in a gaseous ambient.

30. Use of the cantilever array according to claim 1, wherein the cantilever array is used for detecting the presence of a chemical substance in a liquid environment.

31. Use of the cantilever array according to claim 1, wherein the cantilever array is a biosensor.

32. Use of the cantilever array according to claim 1, wherein the cantilever array is a disposable item.
